(19) United States
(12) Patent Application Publication
(10) Pub. No.: US 2016/0112311 A1
(43) Pub. Date: Apr. 21, 2016

(54) ENHANCED CONNECTIVITY TO END DEVICES VIA ACCESS POINTS OF WIRELESS LOCAL AREA NETWORKS (WLAN)

(71) Applicant: GainSpan Corporation, San Jose, CA (US)

(72) Inventors: Pankaj Vyas, Bangalore (IN); Vishal Batra, Bangalore (IN)

(21) Appl. No.: 14/517,949

(22) Filed: Oct. 20, 2014

(51) Int. Cl. H04L 12/741; H04W 40/02

(52) U.S. Cl. CPC H04L 45/74; H04W 40/02; H04W 84/12

(57) ABSTRACT

A wireless node of a wireless network maintains link information for a set of layer-2 addresses, each of the layer-2 addresses corresponding to a medium access control (MAC) address of a corresponding device that transmits packets on the wireless network. The link information indicates whether the corresponding device is in an uplink direction or a downlink direction with respect to the wireless node. The wireless node receives a layer-2 packet in one of the uplink direction and downlink directions, the layer-2 packet containing a layer-2 address specifying a destination system, with no layer-2 address in the layer-2 packet indicating that the packet is destined to the wireless node. The wireless node forwards the layer-2 packet to a next wireless device in one of the uplink direction and downlink direction.

### BACKGROUND

1. Technical Field

Embodiments of the present disclosure relate generally to wireless local area networks (WLAN), and more specifically to providing enhanced connectivity to end devices via access points of WLANs.

2. Related Art

Wireless local area networks (WLAN) are implemented in conformity with IEEE 802.11 family of standards, and provide connectivity via wireless communication medium. End devices refer to source or destination of each packet transmitted on WLANs.

End devices often rely on an access point (AP) for communication with other devices in the WLAN, in which case the WLAN is said to operate in infrastructure BSS mode). APs operate as wireless nodes forwarding each packet until the packet is delivered to the corresponding destination device. Thus when two end devices are connected via the same AP, that AP operates to forward each packet from one of the end devices to the other, and vice versa.

There is a general need to provide enhanced connectivity to end devices via APs of WLANs. For example, it is often desirable that packets be exchanged between an end device associated with one AP and another end device associated with another AP. It may also be desirable that the wireless devices be able to exchange packets with devices connected via Internet as well.

### BRIEF DESCRIPTION OF THE VIEWS OF DRAWINGS

Example embodiments of the present invention will be described with reference to the accompanying drawings briefly described below.

FIG. 1 is a diagram of an example environment in which several aspects of the present disclosure may be implemented.

FIG. 2 is a flow chart illustrating the manner in which link information is created in a wireless node of a WLAN, in an embodiment of the present disclosure.

FIG. 3 is a flowchart illustrating the manner in which a packet is processed in a wireless node of a WLAN, in an embodiment of the present disclosure.

FIG. 4 is a block diagram illustrating the various associations between end devices and wireless nodes in forwarding packets in an embodiment.

FIG. 5A is a diagram of a wireless packet in an embodiment of the present disclosure.

FIG. 5B is a table illustrating the correspondence between address fields and a pair of frame control bits in a packet according to IEEE 802.11 protocol.

FIG. 6A is a diagram showing the contents of a table stored in a wireless node prior to receipt at the wireless node of a DHCP packet from an end device, in an embodiment of the present invention.

FIG. 6B is a diagram showing contents added to a table stored in a wireless node after receipt at the wireless node of a DHCP packet from an end device, in an embodiment of the present invention.

FIG. 6C is a diagram showing contents added to a table stored in a wireless node after receipt at the wireless node of a DHCP packet from another end device, in an embodiment of the present invention.

FIG. 7A is a diagram showing the contents of a table stored in another wireless node prior to receipt at the wireless node of a DHCP packet from an end device, in an embodiment of the present invention.

FIG. 7B is a diagram showing contents added to a table stored in another wireless node after receipt at the wireless node of a DHCP packet from an end device, in an embodiment of the present invention.

FIG. 7C is a diagram showing contents added to a table stored in another wireless node after receipt at the wireless node of a DHCP packet from another end device, in an embodiment of the present invention.

FIG. 8A is a diagram showing the contents of a table stored in yet another wireless node prior to receipt at the wireless node of a DHCP packet from an end device, in an embodiment.

FIG. 8B is a diagram showing contents added to a table stored in yet another wireless node after receipt at the wireless node of a DHCP packet from an end device, in an embodiment of the present invention.

FIG. 9 is a block diagram illustrating the internal functional blocks of a wireless node in an embodiment of the present disclosure.

FIG. 10 is a block diagram showing the internal implementation details of a wireless node in an embodiment of the present disclosure.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION

1. Overview

A wireless node of a wireless network maintains link information for a set of layer-2 addresses, each of the layer-2 addresses corresponding to a medium access control (MAC) address of a corresponding device that transmits packets on the wireless network. The link information indicates whether the corresponding device is in an uplink direction or a downlink direction with respect to the wireless node. The wireless node receives a layer-2 packet in one of the uplink direction and downlink directions, the layer-2 packet containing a layer-2 address specifying a destination system, with no layer-2 address in the layer-2 packet indicating that the packet is destined to the wireless node. The wireless node forwards the layer-2 packet to a next wireless device in one of the uplink direction and downlink direction.

In an embodiment, receipt, at the wireless node, of a DHCP packet enables the wireless node to add the link information in relation to the source system from which the DHCP packet originates.

Several aspects of the invention are described below with reference to examples for illustration. It should be understood that numerous specific details, relationships, and methods are set forth to provide a full understanding of the invention. One skilled in the relevant arts, however, will readily recognize that the invention can be practiced without one or more of the specific details, or with other methods, etc. In other instances, well-known structures or operations are not shown in detail to avoid obscuring the features of the invention.

### 2. Example Environment

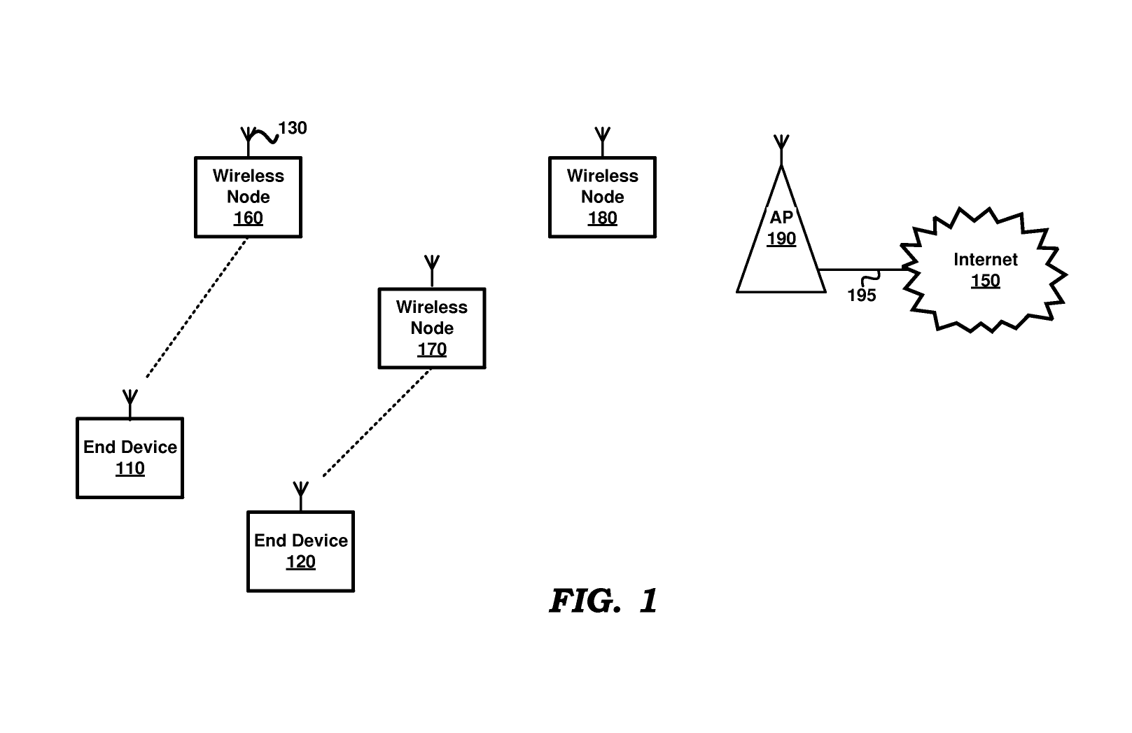

FIG. 1 is a block diagram representing an example environment in which several aspects of the present disclosure can be implemented. The example environment is shown containing only representative devices and systems for illustration. However, real world environments may contain more or fewer systems. FIG. 1 is shown containing end devices 110 and 120, wireless nodes 160, 170 and 180, access point (AP) 190, and Internet 150.

Internet 150 extends the connectivity of end devices to various systems (not shown) connected to Internet 150. Internet 150 may be implemented using protocols such as IP. In general, in IP environments, an IP packet is used as a basic unit of transport, with the source address being set to the IP address assigned to the source system from which the packet originates and the destination address set to the IP address of the destination system to which the packet is to be eventually delivered. The IP packet is encapsulated in the payload of layer-2 packets when being transported across WLANs.

An IP packet is said to be directed to a destination system when the destination IP address of the packet is set to the IP address of the destination system, such that the packet is eventually delivered to the destination system. When the packet contains content such as port numbers, which specifies the destination application, the packet may be said to be directed to such application as well. The destination system may be required to keep the corresponding port numbers available/open, and process the packets with the corresponding destination ports. AP 190 operates as an access point in accordance with 802.11 standards, and routes packets to/from Internet 150, in addition to operating as a Dynamic Host Configuration Protocol (DHCP) server to assign IP addresses to various end devices and wireless nodes, as described in sections below. AP 190 is connected to internet 150 on wired path 195.

End devices 110 and 120 are sources or destinations of various packets. End devices 110 and 120 are shown associated (by corresponding dotted lines) with respective wireless nodes 160 and 170 (operating as APs of corresponding WLANs) in accordance with 802.11 standards. The end device from which a packet originates is referred to as a ‘source system’, while the end device to which a packet is eventually delivered is referred to as a ‘destination system’.

Wireless nodes 160, 170 and 180 (together forming a wireless network) forward packets in accordance with features of the present disclosure to provide enhanced connectivity to end devices 110 and 120. During each hop between a pair of wireless nodes, the transmitting wireless node is referred to as a ‘transmitter’, while the receiver of the packet is referred to as a ‘receiver’. In the first hop, the source system is thus the transmitter. In the last hop, the destination system is the receiver.

End devices 110 and 120, and wireless nodes 160, 170 and 180, and AP 190 together form a wireless mesh network, with AP 190 being the root node of the wireless mesh network. In general, a wireless mesh network is a network in which one or more corresponding wireless nodes/end devices of the wireless mesh network operate to forward packets from another wireless/node/end device until the packet reaches a destination system. The destination system may be an end device within the wireless mesh network itself, or be a device external to the wireless mesh network, such as for example a device (not shown) connected via internet 150. Each of end devices 110 and 120 is capable of operating in power savings mode according to IEEE 802.11 standard.

The flow of packets towards AP 190 is termed as uplink direction, and towards end stations from AP 190 is termed as downlink direction. The operation of each of the wireless nodes is described in sections below. All devices of FIG. 1 except internet 150 are shown containing an antenna, although only the antenna of wireless node 160 is shown numbered (as 130).

According to an aspect of the present disclosure, each of wireless nodes 160, 170 and 180 maintains link information that enables the corresponding wireless node to route packets to the appropriate next hop device in the uplink or downlink direction, and the manner in which such link information is created is described next with respect to a flowchart.

### 3. Creation of Link Information

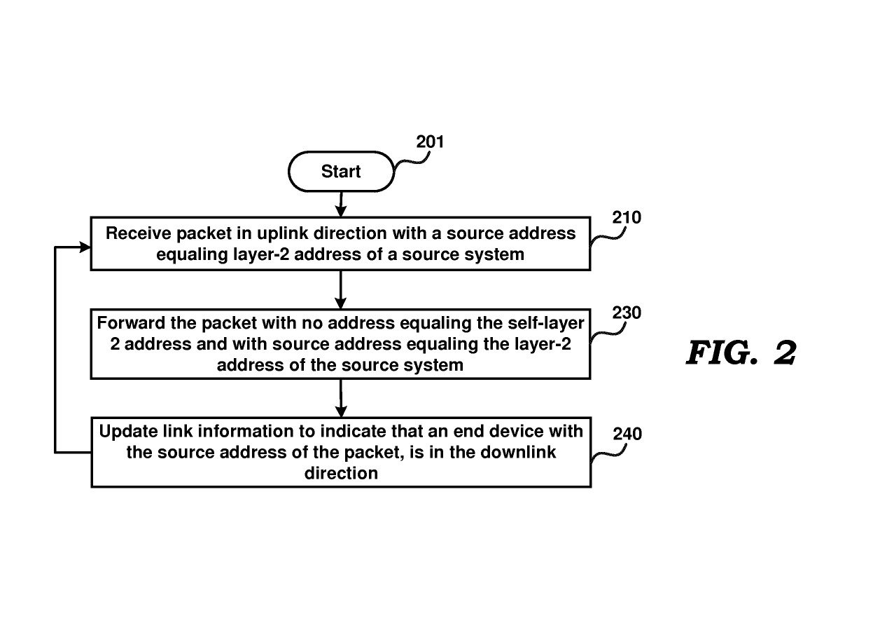

FIG. 2 is a flow chart illustrating the manner in which link information is created in a wireless node of a wireless network, in an embodiment of the present disclosure. The flowchart is described below with respect to wireless node 180 of FIG. 1 merely for illustration. However, the features can be implemented in the other wireless nodes of FIG. 1, as well as other systems and environments also without departing from the scope and spirit of various aspects of the present invention, as will be apparent to one skilled in the relevant arts by reading the disclosure provided herein.

In addition, some of the steps may be performed in a different sequence than that depicted below, as suited to the specific environment, as will be apparent to one skilled in the relevant arts. Many of such implementations are contemplated to be covered by several aspects of the present disclosure. The flow chart begins in step 201, in which control immediately passes to step 210.

In step 210, wireless node 180 receives a packet in the uplink direction with a source address equaling layer-2 address of a source system. As also noted above, the term uplink direction as used herein refers to the direction of packet transfer (or packet movement) from a corresponding device/component of FIG. 1 towards AP 190. Control then passes to step 230.

In step 230, wireless node 180 forwards the packet with no address equaling the self-layer 2 address, and with source address equaling the layer-2 address of source system. The word ‘self’ implies that the layer-2 address is of the same wireless node 180, by which step 230 is performed. Thus, neither the header portion nor the payload portion in the packet forwarded by wireless node 180 contains the layer-2 address of wireless node 180. As described below, in an embodiment, the address of the source system is continued to be transmitted across each hop in the uplink direction. Control then passes to step 240.

In step 240, wireless node 180 updates (or creates if not yet created) the link information to indicate that an end device with the source address of the packet is present in the downlink direction (i.e., in the direction from which the packet is received). Link information refers to information that enables wireless node 180 to appropriately process a packet received from a source system, and may include the layer-2 address of the source system, direction of presence (downlink/uplink) with respect to wireless node 180, the next-hop address to which the packet received from the source system should be forwarded, encryption/decryption keys to be used, etc. Control then passes to step 210, and the steps of the flowchart may be repeated again (for example for another end node in the downlink direction).

In an embodiment of the present disclosure, the steps of the flowchart of FIG. 2 are performed in corresponding wireless nodes (one or more of wireless nodes 160, 170 and 180) after receipt of a broadcast DHCP request packet from any of end devices 110 and 120, or after receipt of broadcast DHCP request packet from another wireless node in the downlink direction. An illustration of the operation of the steps of FIG. 2 in the context of a broadcast DHCP request by end device 110 is described in sections below.

Once each of wireless nodes 160, 170 and 180 is populated with link information of end nodes 110 and 120, as well as of the corresponding wireless nodes in the downlink direct, the wireless nodes participate in exchange of data (information) packets (e.g., in the form of unicast, multicast or broadcast packets) between the corresponding end device and one or more devices in internet 150 or with another end device.

According to an aspect of the present disclosure, a wireless node spoofs layer-2 addresses of one or more other devices (end devices and/or other wireless nodes in the downlink direction). The term “spoofing” as used herein refers to a wireless node either forwarding a packet with the layer-2 address of the spoofed device in the header of the packet (rather than that of the wireless node itself), and picking and processing a packet on the air (wireless medium) that has the destination layer-2 address of the spoofed device (rather than that of the wireless node). In addition, the wireless node sets up and maintain an association according to IEEE 802.11 standards between a spoofed device and the corresponding wireless node.

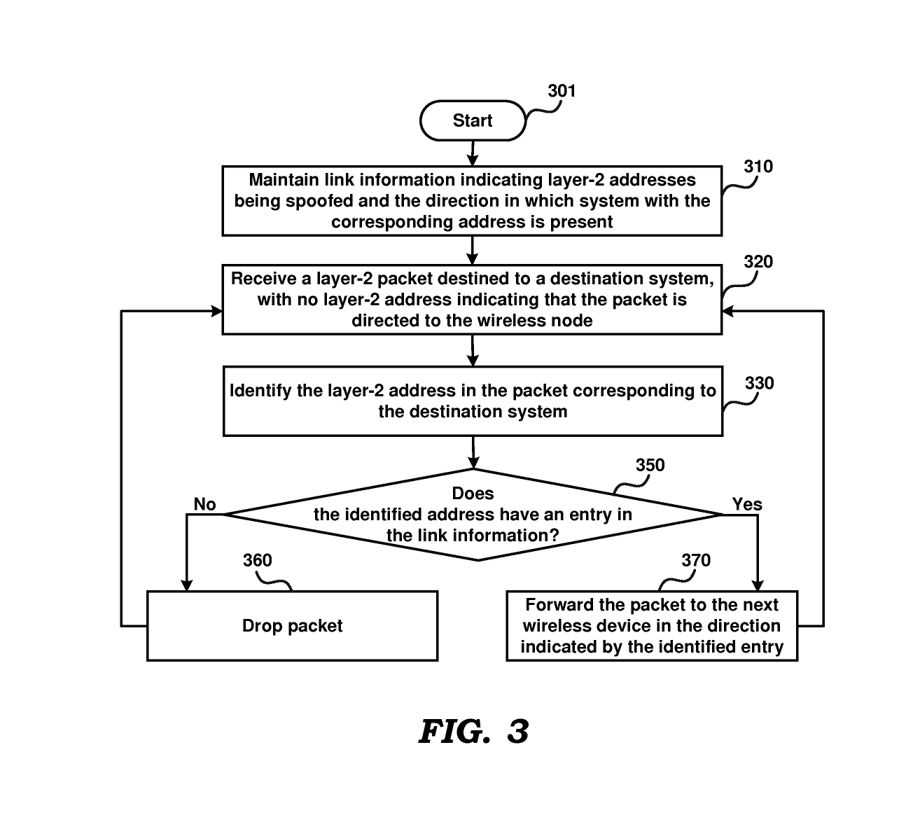

With the layer-2 addresses of the corresponding device in the downlink direction thus spoofed, a wireless node may participate in exchange of data packets between the spoofed device and either another spoofed device or a device in internet 150, as illustrated next with respect to the flowchart of FIG. 3.

### 4. Processing of Packets in a Wireless node

FIG. 3 is a flowchart illustrating the manner in which a packet is processed in a wireless node of a wireless network, in an embodiment of the present disclosure. Again, the flowchart is described below with respect to wireless node 180 of FIG. 1 merely for illustration. However, the features can be implemented in the other wireless nodes of FIG. 1, and other systems and environments also without departing from the scope and spirit of various aspects of the present invention, as will be apparent to one skilled in the relevant arts by reading the disclosure provided herein.

In addition, some of the steps may be performed in a different sequence than that depicted below, as suited to the specific environment, as will be apparent to one skilled in the relevant arts. Many of such implementations are contemplated to be covered by several aspects of the present disclosure. The flow chart begins in step 301, in which control immediately passes to step 310.

In step 310, wireless node 180 maintains link information indicating layer-2 addresses being spoofed, and the direction (uplink or downlink) in which the node with the corresponding address is present. The link information may be created in the manner described above with respect to the steps of the flowchart of FIG. 2. In addition to the spoofed layer-2 addresses and the direction, decryption and encryption keys for the corresponding link may also be maintained. Control then passes to step 320.

In step 320, wireless node 180 receives a layer-2 packet destined to a destination system, with no layer-2 address indicating that the packet is directed to the wireless node. Thus, the packet received by wireless node 180 does not contain the (self) layer-2 address of wireless node 180. Control then passes to step 330.

In step 330, wireless node 180 identifies the layer-2 address in the packet corresponding to the destination system. Wireless node 180 may inspect the destination address field in the received layer-2 packet to identify the layer-2 address of the destination system. Control then passes to step 350.

In step 350, wireless node 180 determines if the identified address has an entry in the maintained link information. If the identified address has an entry in the maintained link information, control passes to step 360. However, if the identified address does not have an entry in the maintained link information, control passes to step 370. For purposes of step 350, a layer-2 broadcast address is deemed to have an entry, requiring the packet to be forwarded in the appropriate direction(s).

In step 360, wireless node 180 drops the packet, i.e., wireless node 180 does not further process or forward the packet. Control then passes to step 320, in which wireless node 180 may receive another layer-2 packet, and the corresponding steps of the flowchart may be repeated.

In step 370, wireless node 180 forwards the packet to the next wireless device in the direction indicated by the identified entry. Forwarding implies that the data bits constituting the packet are transmitted again on the wireless medium to the next wireless device. In case of a broadcast packet, the packet is forwarded in all directions (including the uplink direction, assuming the packet is received from one of the end devices), except the direction in which the packet is received. Control then passes to step 320, in which wireless node 180 may receive another layer-2 packet, and the corresponding steps of the flowchart may be repeated.

The features described above with respect to FIGS. 2 and 3 can be implemented in various embodiments. The features are illustrated in sections below with respect to examples.

### 5. Provisioning

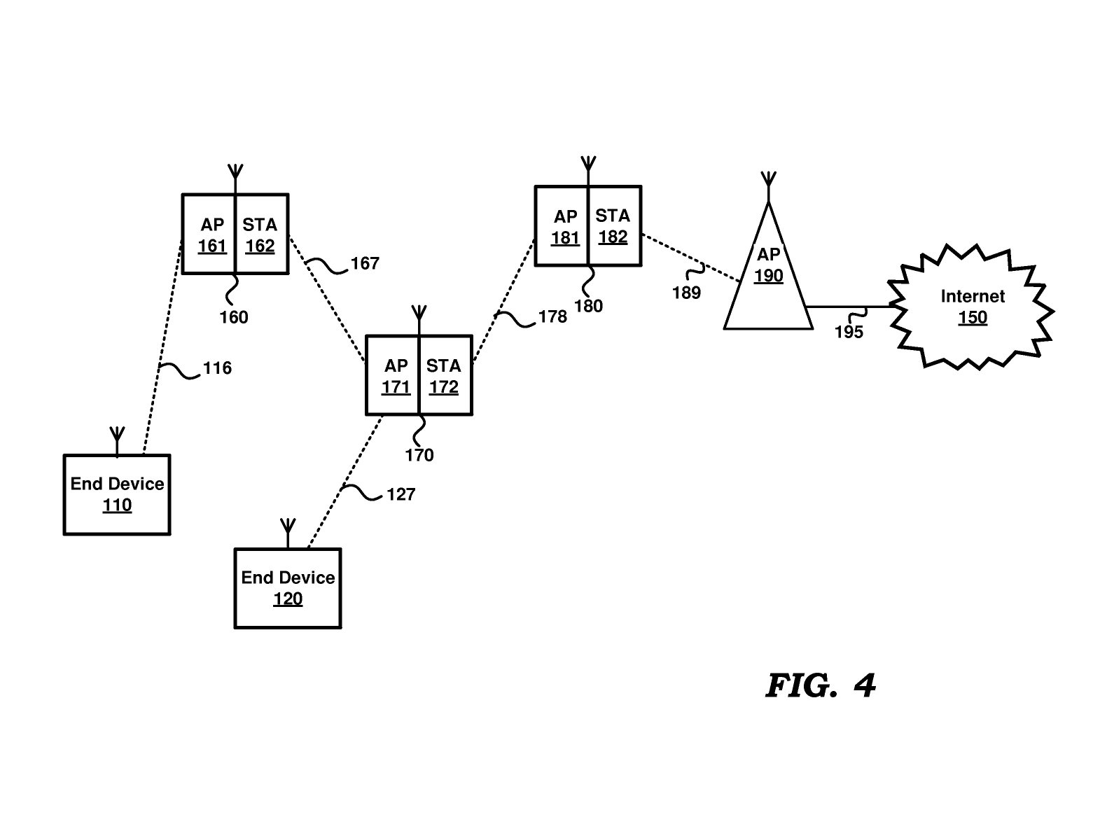

In an embodiment of the present disclosure, each of wireless nodes 160, 170 and 180 of FIG. 1 operates as both an AP and a wireless station (STA), thereby establishing a linear or tree structure within the wireless mesh network of FIG. 1. FIG. 4 is a diagram showing the components/devices/systems of FIG. 1, with each of wireless nodes 160, 170 and 180 shown as the combination of a corresponding AP and STA. Thus, wireless node 160 represents the combination of AP 161 and STA 162, wireless node 170 represents the combination of AP 171 and STA 172, and wireless node 180 represents the combination of AP 181 and STA 182. 1.

Each AP/STA combination may either have separate physical radio interfaces (one radio for AP and another for STA) or have a single radio (single transmit and receive processing chains for both AP and STA). The AP and STA in a wireless node are termed to be operating in the ‘concurrent mode’ when there is time division multiplexing between the AP and STA operations. It is assumed in the representation of FIG. 4 that each AP/STA operates in concurrent mode, and as having a single radio interface and antenna. Each of APs 161, 171 and 181 may have the same SSID (Service Set Identifier) and operate on the same channel/band, or may have different SSIDs and operate in different channels.

A user may provision the corresponding STA in wireless nodes 160, 170 and 180 to associate with corresponding APs. In an embodiment, the provisioning of STAs (e.g., 162, 172 and 182) in wireless nodes is such as to set-up a linear topology of the wireless nodes. In other embodiments of the present disclosure however, provisioning may be done so as to create other types of topologies (such as for example a tree topology). The topology of wireless nodes shown in FIG. 1 is assumed to be a tree. Thus, a user provisions STA 162 to associate (by exchanging corresponding association packets according to IEEE 802.11) with AP 171, STA 172 to associate with AP 181 and STA 182 to associate with AP 190. Assuming another wireless node were to be present in the downlink path, the STA of such wireless node would be provisioned to associate with AP 161, and so on. Dotted lines 167, 178 and 189 represent the association between the corresponding STA and AP.

End devices 110 and 120 (which are also wireless stations or STAs) are assumed to be associated respectively with AP 161 and AP 171, and the respective associations are shown by dotted lines 116 and 127. The combination of an AP and the associated STAs represents an infrastructure basic service set (BSS) according to IEEE 802.11 standards. An AP and the associated STA(s) may cooperatively generate a security key using known techniques (e.g., WPA2 of IEEE 802.11), and each AP and STA is assumed to possess a security key for encryption and decryption of packets.

Each of APs 161, 171 and 181 may operate consistent with the definition of an access point in IEEE 802.11 standards. Thus, APs 161, 171 and 181 may transmit beacons at corresponding intervals, buffer data for STAs associated with them to enable the STAs to transition to power-saving mode/stat, etc. Each of STAs 162, 172 and 182 may operate consistent with the definition of a wireless station (STA) in the infrastructure mode of IEEE 802.11 standards. Thus, the STAs may associate with the corresponding APs, transition to power-saving states, etc.

According to an aspect of the present disclosure, after provisioning, a corresponding device (AP or STA or end device) broadcasts a DHCP request packet for being assigned an IP address, and receipt of a DHCP request packet at a wireless node is the basis for creating link information in the wireless node. A DHCP request packet may be forwarded via the corresponding AP/STA paths (according to the associations provisioned) to the DHCP server in AP 190, and an assigned IP address may be provided in the return path to the requesting device. When the DHCP requester is STA 182, no forwarding is required, since STA 182 is already associated with AP 190 and can request for an IP address directly.

The packet formats and address conventions of packets (including DHCP request packets and data/information packets) used in an embodiment of the present disclosure are briefly described next.

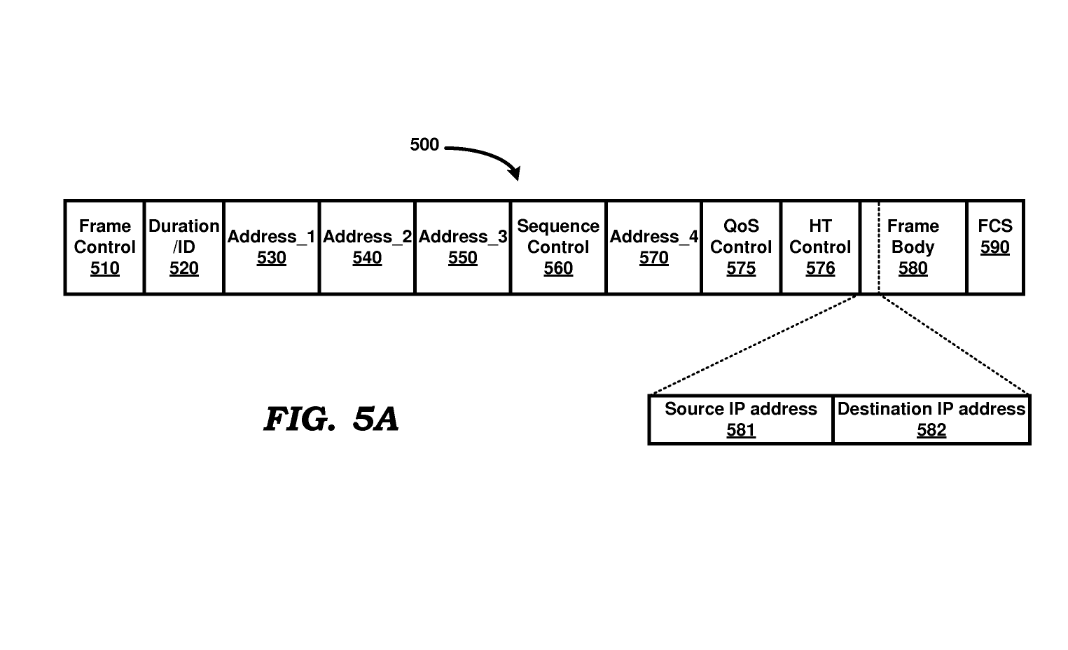

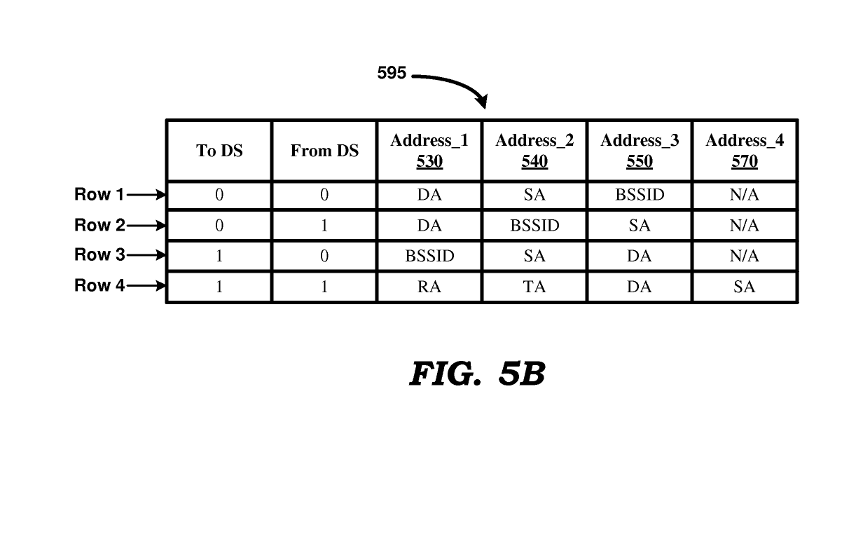

FIG. 5A shows the format of a wireless packet 500 in accordance with IEEE 802.11 standards. Wireless packet 500 is shown containing fields Frame Control 510, Duration/ID 520, Address_1 530, Address_2 540, Address_3 550, Sequence Control 560, Address_4 570, QoS Control 575, HT control 576, Frame Body 580 and FCS 590. When IP header is present, Source IP address 581 and Destination IP address 582 would be contained in Frame Body 580, and respectively represent the IP addresses of the source system of packet 500 and destination system of packet 500 respectively. Frame body 580 additionally contains the payload (data) sought to be transmitted in the packet. A detailed description of the fields of packet 500 is provided in Section 8 of the IEEE Std 802.11-2012 document available with the International Telecommunications Union (ITU). Only those fields as relevant to this disclosure are described herein. It is also noted that, in practice, wireless packet 500 may contain more or fewer fields or proprietary modifications depending on the specific deployment environment. Whether packet 500 contains Address_4 570 or not may be set by the corresponding bit/bits in Frame control 510, per the IEEE 802.11 protocol.

Frame Control 510 internally contains several fields for specifying various frame control parameters such as protocol version, To DS, From DS, Power Management, etc. According to the IEEE 802.11 standards, a logic zero in each of the To DS and From DS fields (row 1 in table 595) signifies that the frame is being transmitted from one wireless station (STA) of an independent BSS (IBSS or ad hoc network) to another wireless station of the IBSS, or is a control or management frame. A logic one in each of the To DS and From DS fields (row 4 in table 595) signifies that the frame is being transferred from one AP to another AP in a wireless distribution system (WDS). A logic zero entry in the To DS field and a logic one entry in the From DS field (row 2 in table 595) signifies that the frame is being transmitted from an AP to a wireless station in an infrastructure BSS. A logic one entry in the To DS field and a logic zero entry in the From DS field (row 3 in table 595) signifies that the frame is being transmitted from a wireless station to the corresponding AP in an infrastructure BSS.

Table 595 of FIG. 5B shows the correspondence between combinations of the To DS and From DS fields and address fields Address_1 530, Address_2 540, Address_3 550 and Address_4 570 according to the IEEE 802.11 protocol. DA represents the MAC address of the destination device for a packet, SA represents the MAC address of the source device of the packet, and BSSID represents the MAC address of the corresponding AP.

In an embodiment of the present disclosure the address convention of row 2 of FIG. 5B is used when a packet is transmitted from an AP to a STA, and the address convention of row 3 of FIG. 5B is used when a packet is transmitted from an AP to a STA. In either case, Address_4 570 is either not present in the packet, or if present is ‘don't care’ field.

The manner in which a DCHP request from a device in the downlink direction is used to create or update link information maintained at each of wireless nodes 160, 170 and 180 is described next with examples.

6. DHCP Broadcasts and Creation of Link Information

According to an aspect of the present disclosure, each STA of a wireless node spoofs the layer-2 address of every device in the downlink direction with respect to the STA. Thus, a packet forwarded by a STA in the uplink direction always contains the layer-2 address of the spoofed device (rather than that of the STA itself). Thus, STA 182 is designed to spoof layer-2 addresses for AP 181, STA 172, AP 171, end device 120, STA 162, AP 161 and end device 110. STA 172 spoofs layer-2 addresses for AP 171, end device 120, STA 162, AP 161 and end device 110. STA 162 spoofs layer-2 addresses for AP 161 and end device 110.

Due to such layer-2 address spoofing by STA of a wireless node, the source address (address_2 in row 3 of table 595 of FIG. 5B) in a packet in the uplink direction is preserved at every hop from a source system to a destination system, thereby enabling the STA (and the AP) of a wireless node to detect presence of a device (other AP or STA, including end devices), and thus to create/update link information for that device (whose address is preserved at each hop) on (or sometime after) receipt of a DHCP request from that device.

To illustrate, after being provisioned (i.e., after association with AP 161), end device 110 broadcasts a DHCP request packet, with Address_1 530 equal to BSSID of AP 161, Address_2 540 equal to its own layer-2 (MAC) address, and Address_3 550 containing FFFF (hexadecimal). FFFF (hexadecimal) in Address_3 550 field indicates that the packet is a broadcast packet. The corresponding fields (such as the contents of Frame Body 580) of the packet may contain data specifying that the packet is a DHCP request packet. AP 161 forwards the packet (with the required changes in the packet) to STA 162 on a path internal to wireless node 160.

STA 162 on receipt of the DHCP request packet determines that end device 110 is present in the downlink direction (based on Address_2 540, which is the address of the source system, here end device 110), and creates link information entries including layer-2 address of end device 110, direction of presence (downlink), and the next-hop address (here AP 171, since STA 162 is associated with AP 171). STA 162 forwards the DHCP request packet to AP 171, with the forwarded packet containing BSSID of AP 171 in the Address_1 530 field, layer-2 (MAC) address (spoofed) of end device 110 in Address_2 540 field, and FFFF (hexadecimal) in Address_3 550 field. AP 171 forwards (with no modification to the packet) the received packet to STA 172 on a path internal to wireless node 170.

STA 172 on receipt of the DHCP request packet determines that end device 110 is present in the downlink direction (based on Address_2 540, which is the address of the source system, here end device 110), and creates link information entries including layer-2 address of end device 110, direction of presence (downlink), and the next-hop address (here AP 181, since STA 172 is associated with AP 181). STA 172 forwards the DHCP request packet to AP 181, with the forwarded packet containing BSSID of AP 181 in the Address_1 530 field, layer-2 (MAC) address (spoofed) of end device 110 in Address_2 540 field, and FFFF (hexadecimal) in Address_3 550 field. AP 181 forwards (with no modification to the packet) the received packet to STA 182 on a path internal to wireless node 180.

STA 182 on receipt of the DHCP request packet determines that end device 110 is present in the downlink direction (based on Address_2 540, which is the address of the source system, here end device 110), and creates link information entries including layer-2 address of end device 110, direction of presence (downlink), and the next-hop address (here AP 190, since STA 182 is associated with AP 191). STA 182 forwards the DHCP request packet to AP 190, with the forwarded packet containing BSSID of AP 190 in the Address_1 530 field, layer-2 (MAC) address (spoofed) of end device 110 in Address_2 540 field, and FFFF (hexadecimal) in Address_3 550 field.

In response to the forwarded DHCP request from STA 182, AP 190 transmits an IP address for end device 110 in a packet, with the destination address in the packet being set to the MAC address of end device 110. Since STA 182 spoofs the layer-2 link between end device 110 and AP 190, STA 182 processes the packet even though none of the address fields in the packet contains the MAC address of STA 182. STA 182 forwards the packet to AP 181. The packet is forwarded in the downlink direction till it is delivered to end device 110.

In the illustration provided above, each of STAs 162, 172 and 182 may additionally store the corresponding security key used for the spoofed link. In other words, a corresponding security key is stored for each spoofed link.

DHCP requests from the other devices present in the downlink direction are similarly processed, with the link information for each device being created and stored locally in the STAs of the corresponding wireless nodes after receipt of the corresponding DHCP request packet. Since STA 182 is associated (due to provisioning by a user) with AP 190, STA 182 obtains an IP address from the DHCP server in AP 190 by sending a DHCP request packet to AP 190. The IP addresses assigned by AP 190 are such that all of wireless nodes 160, 170, and 180, and end devices 110 and 120 are in the same IP subnet, with AP 190 being the edge router for the subnet. While IP addresses are noted as being assigned based on DHCP requests, IP addresses may also be assigned statically. In such a case, the link information described above may be populated when ARP broadcasts are sent (instead of DHCP broadcast) by the end devices.

Thus, STA 182 spoofs layer-2 addresses for AP 181, STA 172, AP 171, end device 120, STA 162, AP 161 and end device 110. AP 181 also creates link information entries specifying which next-hop address a packet received at AP 181 should be forwarded to, and the corresponding security key to be used for encryption or decryption (depending on whether a packet is to be transmitted or a received packet is to be processed), etc.

STA 172 spoofs layer-2 addresses for AP 171, end device 120, STA 162, AP 161 and end device 110. STA 162 spoofs layer-2 addresses for AP 161 and end device 110. The link information stored for such spoofing is described below.

### 7. Link Information in Tables

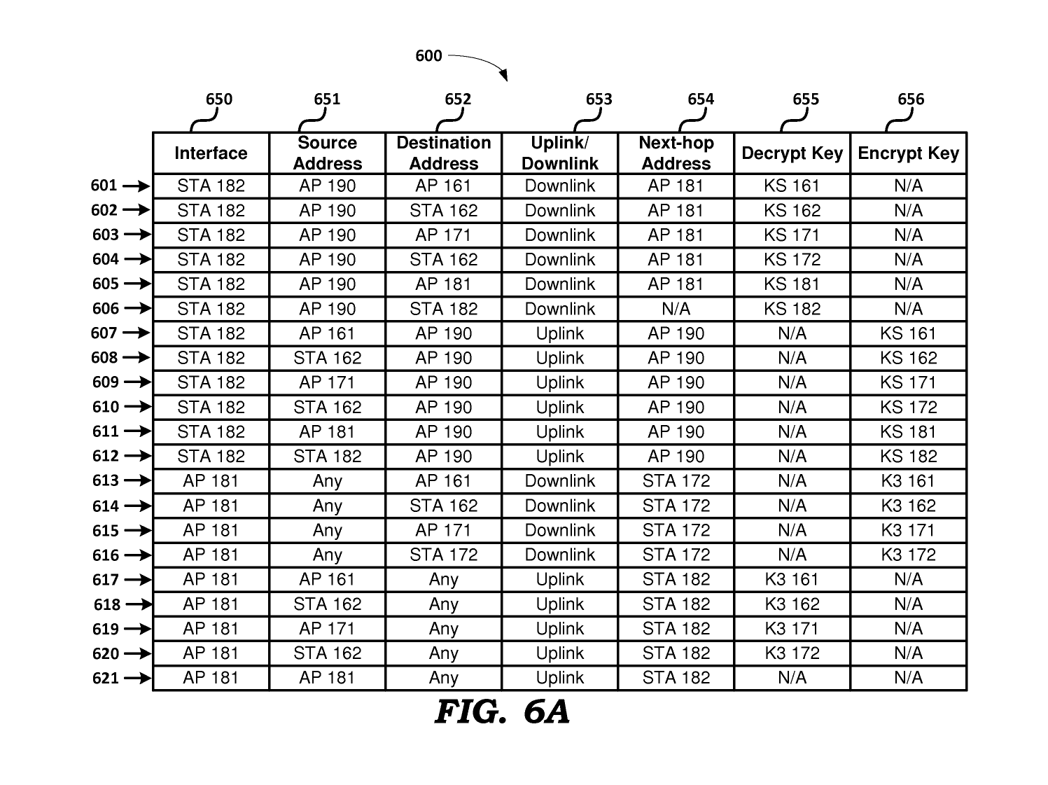

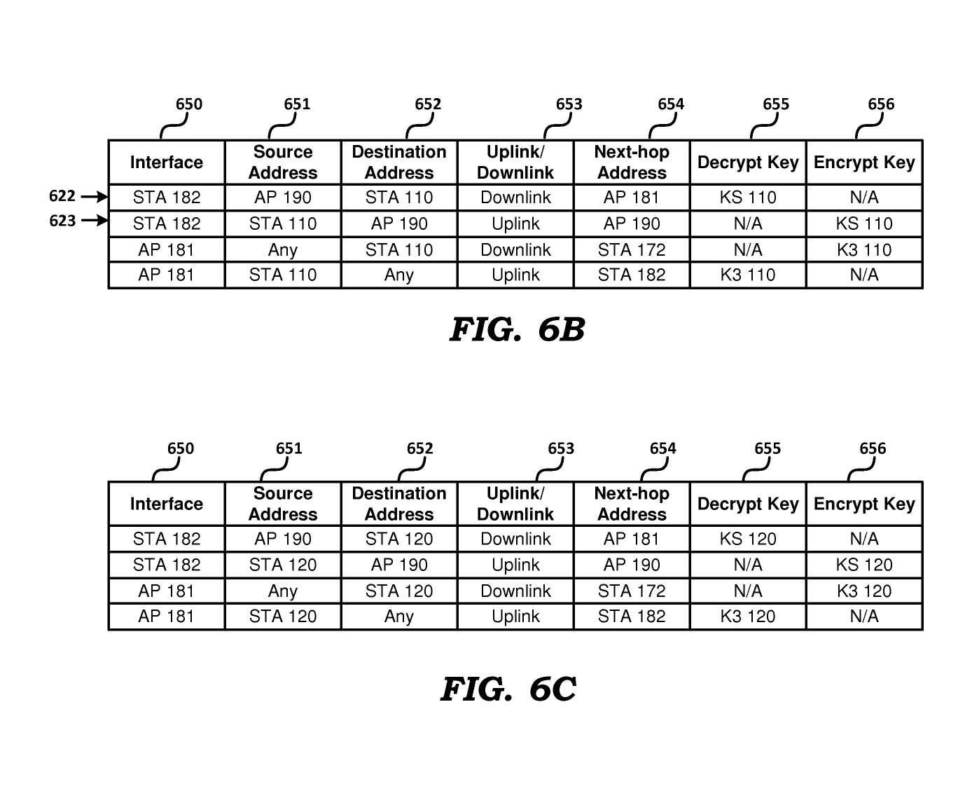

FIG. 6A is a diagram of a table (600) containing link information stored in wireless node 180, prior to reception of a DHCP request packet from either of end devices 110 and 120, but after receipt of DHCP requests from each of AP 181, STA 172, AP 171, STA 162 and AP 161. Column 650 lists the interface (STA 182 or AP 181) on which a corresponding packet is received or transmitted. Column 651 lists the address of the source (source system) of the packet. Column 652 lists the destination (destination system) of the packet. Column 653 lists the direction of packet movement (whether uplink or downlink). Column 654 lists the next-hop address for the packet. Column 655 lists the decrypt key to be used to decrypt the packet (when a packet is received over the air). Column 656 lists the encrypt key to be used to encrypt the packet (when a packet is to be sent on the air). A layer-2 address of a device is denoted by the device reference itself. For example, the address entry “STA 162” in row 608/column 651 is the layer-2 (MAC) address of STA 162.

The entry ‘any’ in column 651 indicates that the source address can be that of any of the devices in the uplink direction with respect to the device/interface in column 650. For example, in row 613, the source address 651 can be that of any of STA 182 and AP 190. The entry ‘any’ in column 652 indicates that the destination address can be that of any of devices in the uplink direction with respect to the device/interface in column 650. For example, in row 617, the destination address 652 can be that of any of STA 182 and AP 190. The entry ‘any’ in the other tables of FIGS. 6B, 6C, 7A, 7B, 7C, 8A and 8B (noted below) have similar meanings with respect to the corresponding device/interface in the ‘interface’ column of the tables. The use of encrypt/decrypt keys shown in FIGS. 6A, 6B, 6C, 7A, 7B, 7C, 8A and 8B is described separately in sections below.

In table 600 of FIG. 6A, rows 601 through 606 list the corresponding entries for the columns 650-656 when STA 182 of wireless node 180 receives a packet from AP 190, and with destination address in the packet as listed in column 652. Since STA 182 spoofs the layer-2 addresses of AP 181, STA 172, AP 171, STA 162 and AP 161, STA 182 picks and processes packets with these destination addresses (even though the packets do not contain the MAC address of STA 182).

Rows 607 through 611 list the corresponding entries for the columns 650-656 when STA 182 receives a packet whose sources are respectively AP 161, STA 162, AP 171, STA 172 and AP 181. Row 612 list the entries when STA 182 is the source of a packet. Although not shown in table 600, STA 182 would forward the corresponding packet to AP 190 with the source address field in the packet containing the layer-2 (MAC) address of the corresponding (spoofed) source, as noted above.

Rows 613 through 616 list the corresponding entries for the columns 650-656 when AP 181 receives a packet whose destinations are respectively AP 161, STA 162, AP 171 and STA 172. Rows 617 through 621 list the corresponding entries for the columns 650-656 when AP 181 receives a packet whose sources are respectively AP 161, STA 162, AP 171, STA 172 and AP 181.

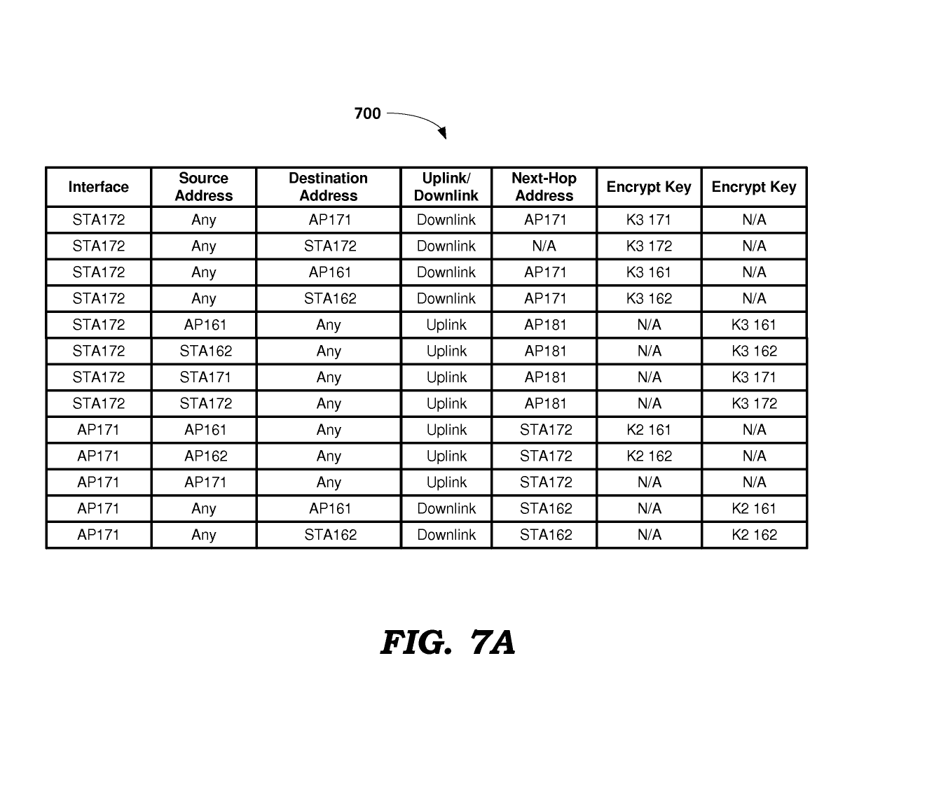

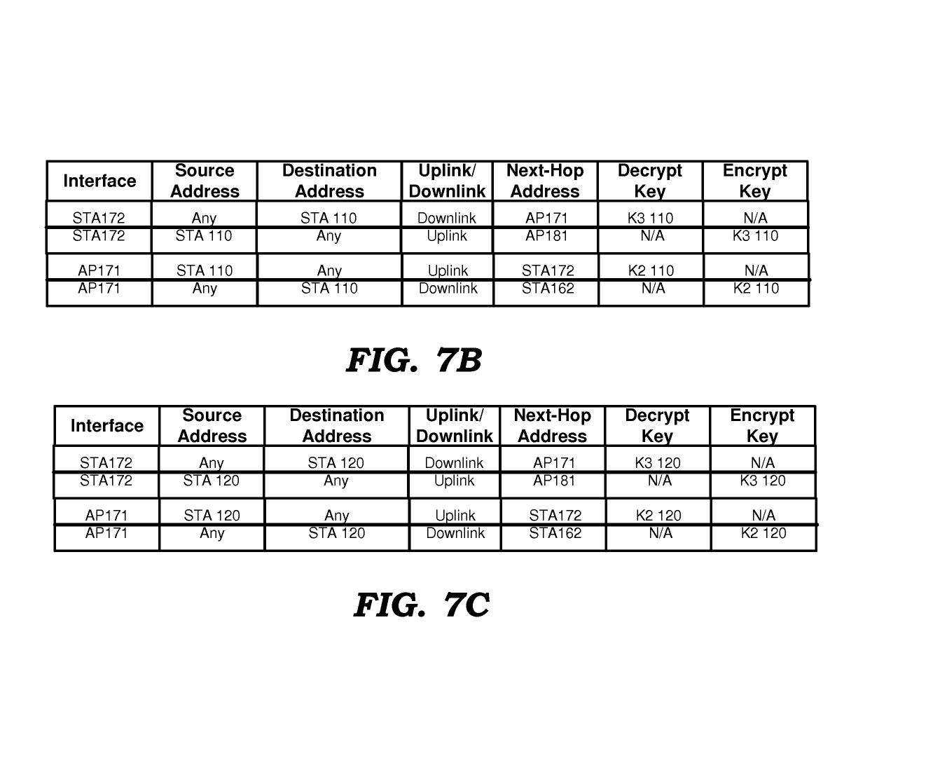

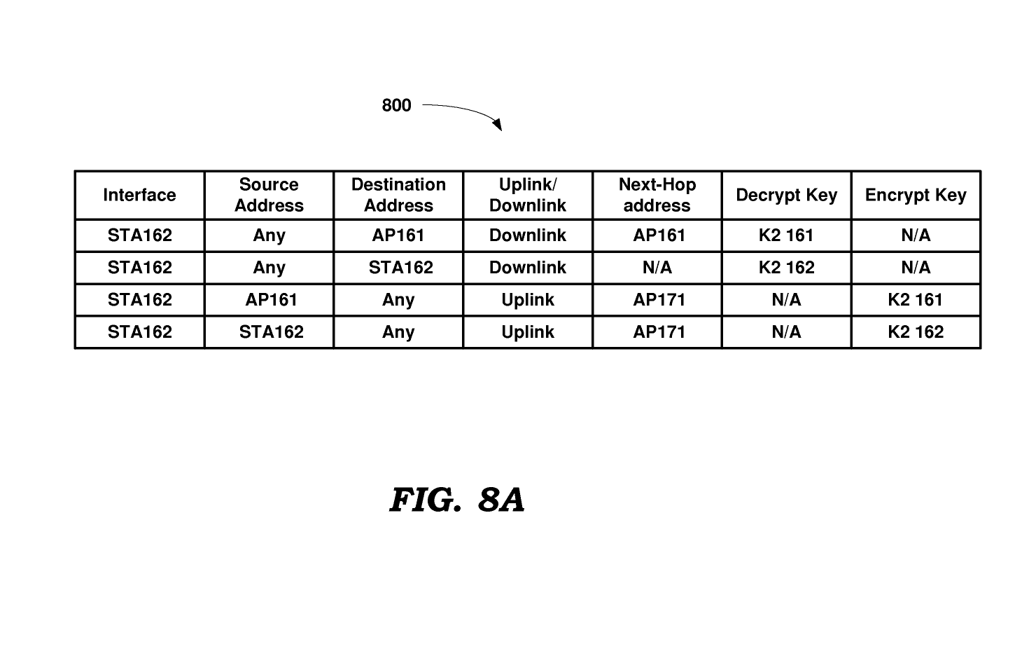

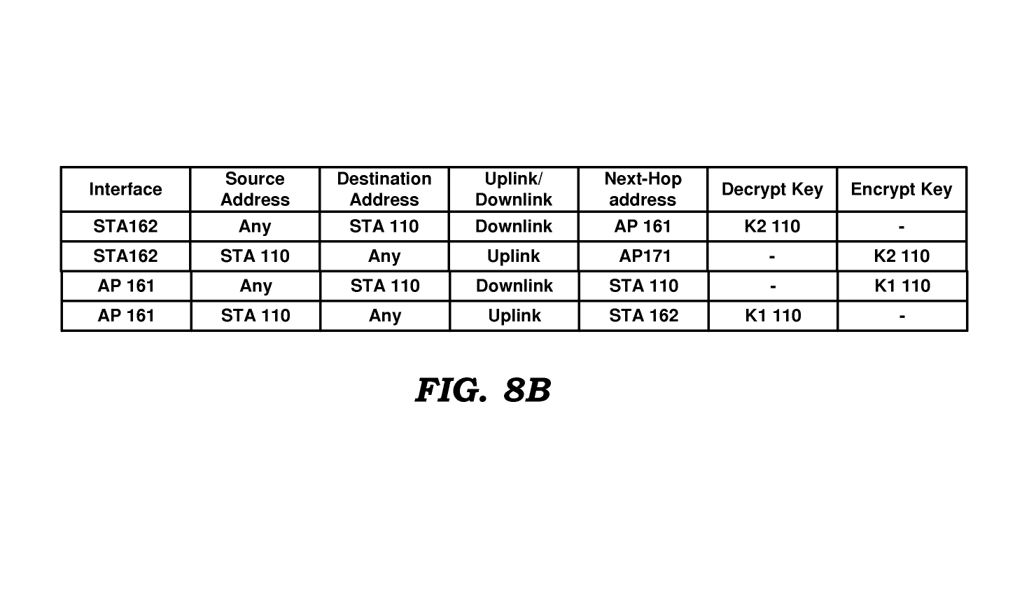

The same convention as for the entries of the rows and columns in FIG. 6A are used in FIGS. 6B and 6C (as also for FIGS. 7A-7C and 8A-8B referred to below). FIG. 7A is a diagram of a table (700) containing link information stored in wireless node 170, prior to reception of a DHCP request packet from either of end devices 110 and 120, but after receipt of DHCP requests from each of AP 171, STA 162 and AP 161. FIG. 8A is a diagram of a table (800) containing link information stored in wireless node 160, prior to reception of a DHCP request packet from end device 110, but after receipt of DHCP request from AP 161.

FIG. 6B lists the additional link information created (and added to table 600 of FIG. 6A) in wireless node 180 after reception of a DHCP request packet from end device 110. FIG. 7B lists the additional link information created (and added to table 700 of FIG. 7A) in wireless node 170 after reception of a DHCP request packet from end device 110. FIG. 8B lists the additional link information created (and added to table 800 of FIG. 8A) in wireless node 160 after reception of a DHCP request packet from end device 110.

FIG. 6C lists the link information created (and added to table 600 of FIG. 6A) in wireless node 180 after reception of a DHCP request packet from end device 120. FIG. 7C lists the link information created (and added to table 700 of FIG. 7A) in wireless node 170 after reception of a DHCP request packet from end device 120.

It may be observed from FIGS. 6A, 6B and 6C that STA 182 spoofs layer-2 addresses for AP 181, STA 172, AP 171, end device 120, STA 162, AP 161 and end device 110. Thus, STA 182 picks up and processes a packet received from AP 190, even when the destination address of the packet is the MAC address of any of AP 181, STA 172, AP 171, end device 120, STA 162, AP 161 and end device 110. Similarly, when forwarding (to AP 190) a packet received from any of sources AP 181, STA 172, AP 171, end device 120, STA 162, AP 161 and end device 110, STA 182 places the layer-2 address of the source system (rather than its own layer-2 address) in the source address field of the packet.

Again, it may be observed from FIGS. 7A, 7B and 7C that STA 172 spoofs layer-2 addresses for AP 171, end device 120, STA 162, AP 161 and end device 110. Thus, STA 172 picks up and processes a packet received from a device in the uplink direction even when the destination address of the packet is the layer-2 address of any of AP 171, end device 120, STA 162, AP 161 and end device 110. Similarly, when forwarding (to a corresponding device in the uplink direction) a packet received from any of sources AP 171, end device 120, STA 162, AP 161 and end device 110, STA 172 places the layer-2 address of the source system (rather than its own layer-2 address) in the source address field of the packet.

It may be observed from FIGS. 8A and 8B that STA 162 spoofs layer-2 addresses for AP 161 and end device 110. Thus, STA 162 picks up and processes a packet received from a device in the uplink direction even when the destination address of the packet is the layer-2 address of any of AP 161 and end device 110. Similarly, when forwarding (to a corresponding device in the uplink direction) a packet received from any of sources AP 161 and end device 110, STA 172 places the layer-2 address of the source system (rather than its own layer-2 address) in the source address field of the packet.

With the link information thus created, end devices 110 and 120 may exchange data (information) packets with each other and/or with one or more devices in internet 150. It is noted that exchange of packets between end devices 110 and 120 (in general, between any pair of nodes of FIG. 4 other than a device in internet 150) does not require IP, since wireless nodes 160 and 170 maintain link information that enables delivery of packets from one of the end devices to the other. Accordingly, the wireless network and WLANs noted above, together are viewed as one sub-net from the perspective of IP network, as will be clear from the description below.

### 8. Connectivity via Internet

Communication between an end device and one or more devices in internet 150 may require IP to enable routing of the packet beyond AP 190 (i.e. within internet 150). Accordingly, packets destined to devices in internet 150 and originating from either end device 110 or 120 (or the other nodes of FIG. 4, excluding devices in internet 150) are IP packets having headers with the corresponding source and destination IP addresses. Each IP packet is in the payload portion of a layer-2 packet.

To send an IP packet on Internet, end device encapsulates the IP packet with layer-2 header according to row 3 of FIG. 5B. Address_3 there is set to the layer-2 address of AP 190 and sent to AP 161. In view of the link information maintained by each of the wireless nodes, the layer-2 packet is delivered to AP 190, which de-encapsulates the layer-2 header, examines the resulting IP packet and forwards the packet on Internet 150 to a machine having an IP address equaling the destination IP address in the packet.

When an IP packet is received, AP 190 may examine a local table, which maps the destination IP address of the packet to a corresponding layer-2 address. The IP packet is encapsulated with a layer-2 header in accordance with row 2 of the Table of FIG. 5B. Address_1 (DA) of the packet is set to the mapped layer-2 address. The layer-2 packet thus formed is sent to STA 182, and is thereafter spoofed by wireless nodes 180, 170 and 160 in accordance with the description provided above until the packet is delivered to end device 110 (assuming the IP destination address is that of end device 110).

An entry corresponding to each device may be formed in the local table (though not shown) as the first packet (e.g., DHCP) is received from that device. Alternatively, ARP type protocols may be employed by AP 190 to ascertain the corresponding layer-2 address. Thus, end devices are provided connectivity via IP protocol also.

The description is continued with respect to the manner in which each layer-2 link can be made secure.

### 9. Security

It is noted here that in addition to spoofing a layer-2 address of a device, each of the STAs 162, 172 and 182 establish an association (as defined in the IEEE 802.11 standards) between a spoofed device and a corresponding AP. Thus, for example, STA 182 may establish (separate) associations with AP 190 for each of AP 181, STA 172, AP 171, end device 120, STA 162, AP 161 and end device 110 (total of seven separate associations, in addition to an association between STA 182 itself and AP 190).

For each association, a single/same security key (for both encryption and decryption at the corresponding ends) is maintained in wireless node 180. Since STA 182 maintains eight associations with AP 190 (seven spoofed associations and one for itself), a total of eight security keys are maintained and used by STA 182. The eight keys are KS 161, KS 162, KS 171, KS 172, KS 181, KS 182 (which are listed in FIG. 6A), KS 110 (listed in FIG. 6B), and KS 120 (listed in FIG. 6C).

Thus, referring to FIG. 6B, for example, key KS 110 is maintained at STA 182. As indicated in row 622 of FIG. 6B, when STA 182 receives packet from AP 190 with STA 110 being the destination (destination system), STA 182 uses key KS 110 to decrypt the packet. When STA 182 transmits a packet to AP 190 with STA 110 being the source system (originator of the packet), STA 182 uses key KS 110 to encrypt the packet prior to transmission.

Since a total of six associations are maintained by STA 172 with AP 181 (five spoofed associations and one for itself), a total of six security keys are maintained and used by STA 172. The six keys are K3 161, K3 162, K3 171, K3 172 (which are listed in FIG. 7A), K3 110 (shown in FIG. 7B), and K3 120 (shown in FIG. 6C).

Similarly, since a total of three associations are maintained by STA 162 with AP 1711 (two spoofed associations and one for itself), a total of three security keys are maintained and used by STA 162. The three keys are K2 161 and K2 162 (which are listed in FIG. 7A), and K2 110 (listed in FIG. 8B). AP 161 additionally maintains security key K110 for the association between end device 110 and AP 162. The security keys used by AP 171 and AP 181 are listed in the corresponding tables of FIGS. 6A, 6B, 6C, 7A, 7B and 7C.

The description is continued with an illustration of the internal functional blocks of a wireless node in an embodiment of the present disclosure.

### 10. Wireless node

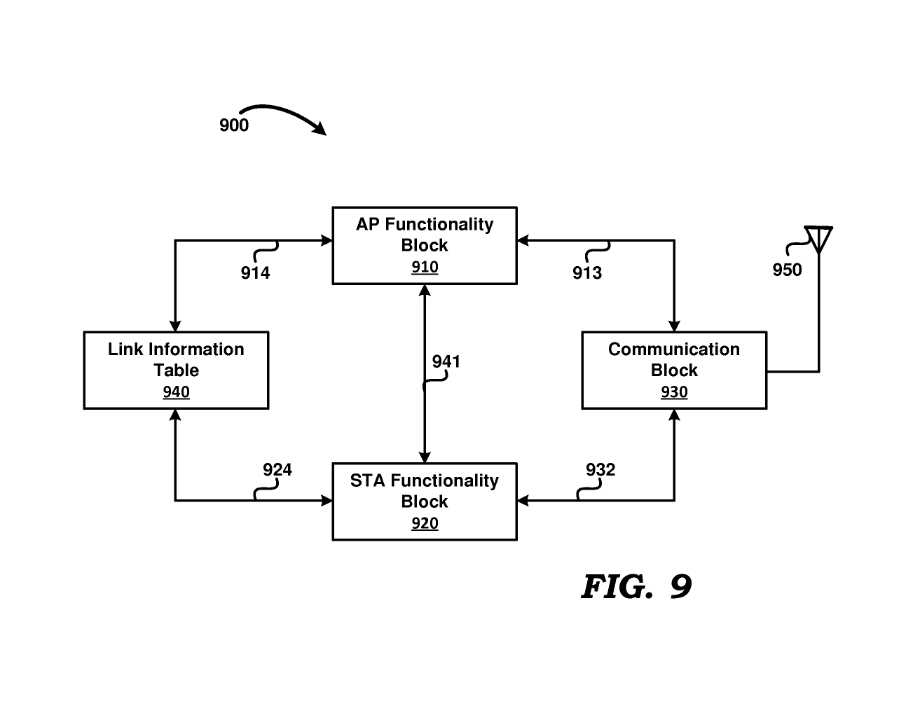

FIG. 9 is a block diagram illustrating the internal functional blocks of a wireless node in an embodiment of the present disclosure. Wireless node 900 is shown containing AP functionality block 910, STA functionality block 920, communication block 930, link information table 940 and antenna 950. Wireless node 900 may correspond to any of the wireless nodes 170, 170 and 180.

Communication block 930 performs transmit and receive processing operations in wireless node 900. Communication block 930 may receive a packet on a wireless medium via antenna 950. Communication block 930 forwards the packet, on path 913, to AP functionality block 910 if the BSSID field (Address_1 530) equals the MAC address of the AP (AP functionality block 910) of wireless node 900. Communication block 930 forwards the packet, on path 923, to STA functionality block 920 if the Address_2 540 field contains the BSSID of the AP to which the STA (STA functionality block 920) of wireless node 900 is associated. Communication block 930 may receive packets from AP functionality block 910 and STA functionality block 920, and transmit the packets on the wireless medium via antenna 950.

Link information table 940 contains layer-2 link information created, maintained and updated by wireless node 900. Thus, for example, when wireless node 900 represents wireless node 180, link information table 940 represents table 600, the details of which are shown in FIGS. 6A, 6B and 6C. Link information table 940 is accessible by AP functionality block 910 via path 914, and by STA functionality block 920 via path 924.

AP functionality block 910 performs the AP functions of wireless node 900. Thus, for example, when wireless node 900 represents wireless node 180 (FIG. 4), AP functionality block 910 performs the operations performed by AP 181. Thus, AP functionality block 910 may receive a packet on path 913, and determine if the destination system for the packet is AP functionality block 910 or not (i.e., whether the destination system for the packet is the AP of wireless node 900 or not). If the destination system is AP functionality block 910, AP functionality block 910 may suitably process the packet (e.g., as specified by the IEEE 802.11 standard). Otherwise, the next-hop address is that of the STA of wireless node 900, i.e., STA functionality block 920, and AP functionality block 910 forwards the packet (with suitable modifications if necessary) to STA functionality block 910 on path 941. In either case, AP functionality block 910 may decrypt the packet with the corresponding decrypt key, as noted above.

AP functionality block 910 may receive a packet from STA functionality block 920 on path 914, and determine if the destination system for the packet is AP functionality block 910 or not If the destination system is AP functionality block 910, AP functionality block 910 may suitably process the packet. Otherwise, AP functionality block 910 performs a look-up of link information table 940 to determine the next-hop address for the packet, form the packet headers correspondingly (address fields, etc.), encrypt the packet with the corresponding encrypt key, and provide the packet to communication block 930 for transmission via antenna 950.

STA functionality block 920 performs the STA functions of wireless node 900. Thus, for example, when wireless node 900 represents wireless node 180 (FIG. 4), STA functionality block 920 performs the operations performed by STA 182. Thus, STA functionality block 920 may receive a packet on path 932, and determine if the destination system for the packet is STA functionality block 920 or not (i.e., whether the destination system for the packet is the STA of wireless node 900 or not). If the destination system is STA functionality block 920, STA functionality block 920 may suitably process the packet (e.g., as specified by the IEEE 802.11 standard). Otherwise, the next-hop address is that of the AP of wireless node 900, i.e., AP functionality block 910, and STA functionality block 920 forwards the packet to AP functionality block 910 on path 941. In either case, STA functionality block 920 may decrypt the packet with the corresponding decrypt key, as noted above.

STA functionality block 920 may receive a packet from AP functionality block 910 on path 914, and determine if the destination system for the packet is STA functionality block 920 or not If the destination system is STA functionality block 920, STA functionality block 920 may suitably process the packet. Otherwise, STA functionality block 920 performs a look-up of link information table 940 to determine the next-hop address for the packet, form the packet headers correspondingly (address fields, etc.), encrypt the packet with the corresponding encrypt key, and provide the packet to communication block 930 for transmission via antenna 950.

Each of AP functionality block 910 and STA functionality block 920 may receive DHCP requests from other devices (in the downstream direction), and create/update link information table 940 in the manner described above in detail. Although not shown in FIG. 9, wireless node 900 may contain other blocks such as input block (for receiving provisioning inputs, passwords/passphrases, etc.), output block (for display of relevant contents on a display unit), etc.

The description is continued with an illustration of the hardware implementation of a wireless node, in an embodiment of the present disclosure.

### 11. Hardware Implementation

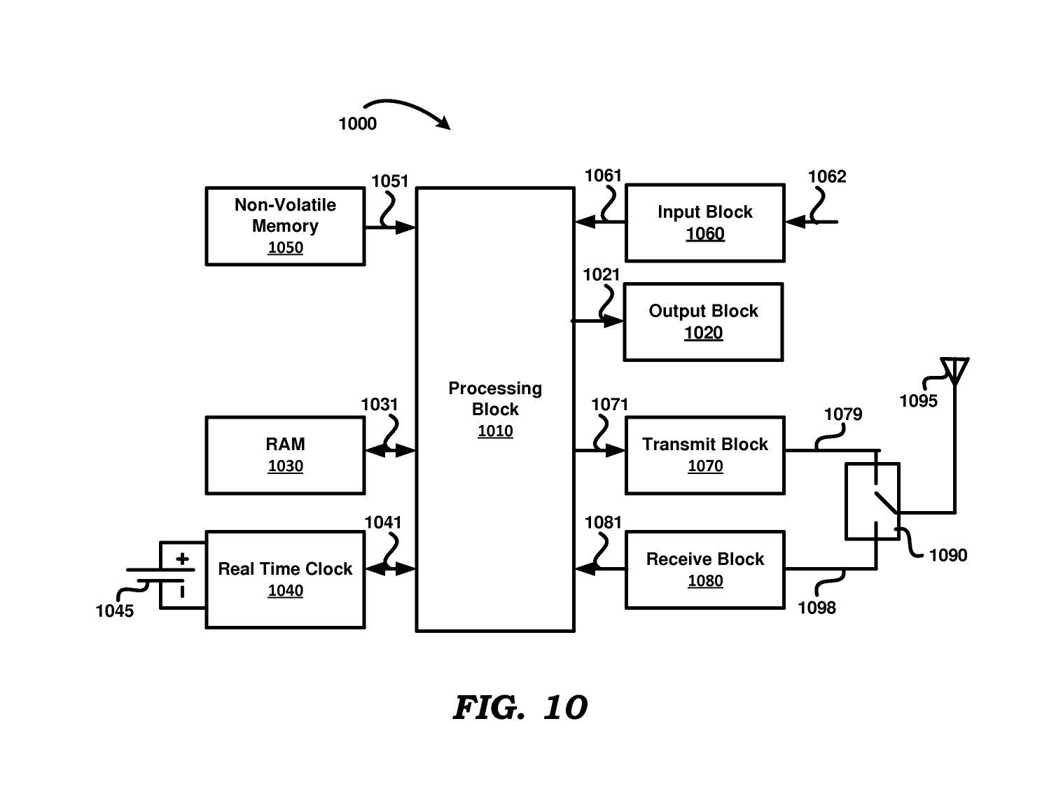

FIG. 10 is a block diagram showing the hardware implementation details of a wireless node in an embodiment of the present disclosure. Wireless node 1000 may correspond to any of wireless nodes 160, 170 and 180 of FIG. 1 or FIG. 4. Wireless node 1000 is shown containing processing block 1010, output block 1020, random access memory (RAM) 1030, real-time clock (RTC) 1040, battery 1045, non-volatile memory 1050, input block 1060, transmit block 1070, receive block 1080, hardware wireless node 1090 and antenna 1095. The whole of wireless node 1000 may be implemented as a system-on-chip (SoC), except for battery 1045 and antenna 1095. Alternatively, the blocks of FIG. 10 may be implemented on separate integrated circuits (IC).

The components/blocks of wireless node 1000 are shown merely by way of illustration. However, wireless node 1000 may contain more or fewer components/blocks. Further, although not shown in FIG. 10, all blocks of wireless node 1000 may be connected automatically to an auxiliary power source (such as battery 1045) in the event of failure of main power source (not shown).

Input block 1060 enables user inputs on path 1062 to be provided to wireless node 1000. Input block 1060 may be provided in the form of a keypad. Output block 1020 enables wireless node 1000 to provide outputs (received on path 1021) to a user, and may be provided in the form of a display unit.

Antenna 1095 (which is equivalent to antenna 950 of FIG. 10) operates to receive from, and transmit to, a wireless medium, corresponding data packets. Hardware wireless node 1090 may be controlled by processing block 1010 (connection not shown) to connect antenna 1095 either to receive block 1080 via path 1098, or to transmit block 1070 via path 1079, depending on whether wireless node 1000 (or the corresponding AP and STA functionality within wireless node 1000) is to receive or transmit.

Transmit block 1070 receives data to be transmitted on path 1071 from processing block 1010, generates a modulated radio frequency (RF) signal according to IEEE 802.11 standards, and transmits the RF signal via wireless node 1090 and antenna 1095. Receive block 1080 receives an RF signal bearing data via wireless node 1090, path 1098 and antenna 1095, demodulates the RF signal, and provides the extracted data to processing block 1010 on path 1081.

RTC 1040 operates as a clock, and provides the ‘current’ time to processing block 1010 on path 1041. RTC 1040 may be backed-up by battery 1045 (in addition to the normal source of power, not shown in the Figure). Although not shown as such in FIG. 10, battery 1045 may also be used as back-up power to one or more of the other components/blocks of station 1000.

Non-volatile memory 1050 is a non-transitory machine readable medium, and stores instructions, which when executed by processing block 1010, causes wireless node 1000 to operate as described above. The instructions include those that implement AP functionality block 910 and STA functionality block 920 described with respect to FIG. 9, and for those blocks to operate as described above. In particular, the instructions enables wireless node 1000 to operate as described with respect to the flowcharts of FIGS. 2 and 3.

Processing block 1010 (or processor in general) may contain multiple processing units internally, with each processing unit potentially being designed for a specific task. Alternatively, processing block 1010 may contain only a single general-purpose processing unit. Processing block 1010 may execute instructions stored in non-volatile memory 1050 or RAM 1030 to enable wireless node 1000 to operate according to several aspects of the present disclosure, described above in detail.

RAM 1030 is a volatile random access memory, and may be used for storing instructions and data. Thus, the relevant tables of FIGS. 6A, 6B, 6C, 7A, 7B, 7C, 8A and 8B maintained by wireless node 1000 may be stored in RAM 1030.

RAM 1030 and non-volatile memory 1050 (which may be implemented in the form of read-only memory/ROM/Flash) constitute computer program products or machine (or computer) readable medium, which are means for providing instructions to processing block 1010. Thus, such medium can be in the form of removable (floppy, CDs, tape, etc.) or non-removable (hard drive, etc.) medium. Processing block 1010 may retrieve the instructions (via corresponding paths 1051 and 1031), and execute the instructions to provide several features of the present disclosure.

### 12. Conclusion

References throughout this specification to “one embodiment”, “an embodiment”, or similar language means that a particular feature, structure, or characteristic described in connection with the embodiment is included in at least one embodiment of the present invention. Thus, appearances of the phrases “in one embodiment”, “in an embodiment” and similar language throughout this specification may, but do not necessarily, all refer to the same embodiment.

While various embodiments of the present invention have been described above, it should be understood that they have been presented by way of example only, and not limitation. Thus, the breadth and scope of the present invention should not be limited by any of the above-described embodiments, but should be defined only in accordance with the following claims and their equivalents.

What is claimed is:

1. A method implemented in a wireless node of a wireless network, said method comprising:
maintaining link information for a set of layer-2 addresses, each layer-2 address corresponding to a medium access control (MAC) address of a corresponding device transmitting packets on said wireless network, said link information indicating whether the corresponding device is in an uplink direction or a downlink direction;
receiving, by said wireless node, a first layer-2 packet on a wireless medium in one of said uplink direction and said downlink direction, said first layer-2 packet containing a first layer-2 address specifying a destination system, with no layer-2 address in said first layer-2 packet indicating that the packet is destined to said wireless node; and
forwarding, by said wireless node, said first layer-2 packet on said wireless medium to a next wireless device in said one of said uplink direction and said downlink direction.

2. The method of claim 1, wherein said packet is received in said downlink direction to a first end device as said destination system, wherein said first layer-2 address is that of said first end device, said method further comprising:
operating both as an access point (AP) and a wireless station (STA) according to IEEE 802.11 standards, wherein said STA of said wireless node associates with an AP of a second wireless node, and a STA of a third wireless node associating with said AP of said wireless node, wherein said wireless node, said second wireless node and said third wireless node are in a path to said first end device, wherein said second wireless node is after said wireless node in said uplink direction, and said third wireless node is before said wireless node in said uplink direction, wherein said first layer-2 packet is received by said STA of said wireless node from said AP of said second wireless node, and said first layer-2 packet is forwarded by said AP of said wireless node to said STA of said third wireless node.

3. The method of claim 2, wherein said first layer-2 packet does not contain a layer-2 address of any of said second wireless node, said wireless node and said third wireless node as a destination address, while being forwarded in said path.

4. The method of claim 2, wherein said first layer-2 address is a unicast address, said method further comprising:
examining said link information for an entry corresponding to said first layer-2 address of said end device,
wherein said first layer-2 packet is forwarded by said AP of said wireless node to said STA of said third wireless node only if said entry is present in said link information.

5. The method of claim 4, further comprising:
receiving, by said wireless node, a second layer-2 packet on said wireless medium in said uplink direction, said second layer-2 packet containing said first layer-2 address of said first end device indicating that said first end device is said source system for said second layer-2 packet;
forwarding said second layer-2 packet with no source address equaling a layer-2 address of said AP of said wireless node or said STA of said wireless node, but with a source address equaling said first layer-2 address of said end device; and
updating, in said wireless node, said link information to indicate that said end device is present in said downlink direction,
wherein said second layer-2 packet is received before said first layer-2 packet.

6. The method of claim 5, wherein said second layer-2 packet is a layer-2 broadcast packet according to dynamic host configuration protocol (DHCP) for obtaining an IP address for said first end device,
wherein said layer-2 broadcast packet is forwarded by said wireless node to said AP of said second wireless node as being the next node in said uplink direction in view of an association of the STA of said wireless node with said AP of said second wireless node,
wherein said first layer-2 packet is received as a response to said layer-2 broadcast packet from a DHCP server also operating as a corresponding AP.

7. The method of claim 5, wherein said STA of said wireless node establishes an association between said first end device and said AP of said second wireless node, said association being according to IEEE 802.11 standard,
wherein said STA of said wireless node encrypts said second layer-2 packet with a first security key corresponding to said association between said first end device and said AP of said second wireless node, and forwards a first encrypted second layer-2 packet to said AP of said second wireless node,
wherein said AP of said second wireless node decrypts said first encrypted second layer-2 packet using said first security key to obtain said second layer-2 packet.

8. The method of claim 7, wherein said STA of said third wireless node establishes an association between said first end device and said AP of said wireless node, said association being according to IEEE 802.11 standard,
wherein, said STA of said third wireless node encrypts said second layer-2 packet with a second security key corresponding to said association between said first end device and said AP of said wireless node, and forwards a second encrypted second layer-2 packet to said AP of said wireless node,
wherein said AP of said wireless node decrypts said second encrypted second layer-2 packet using said second security key to obtain said second layer-2 packet.

9. A non-transitory machine readable medium storing one or more sequences of instructions for operating a wireless node of a wireless network, wherein execution of said one or more instructions by one or more processors contained in said wireless node enables said wireless node to perform the actions of:
maintaining link information for a set of layer-2 addresses, each layer-2 address corresponding to a medium access control (MAC) address of a corresponding device transmitting packets on said wireless network, said link information indicating whether the corresponding device is in an uplink direction or a downlink direction;
receiving, by said wireless node, a first layer-2 packet on a wireless medium in one of said uplink direction and said downlink direction, said first layer-2 packet containing a first layer-2 address specifying a destination system, with no layer-2 address in said first layer-2 packet indicating that the packet is destined to said wireless node; and
forwarding, by said wireless node, said first layer-2 packet on said wireless medium to a next wireless device in said one of said uplink direction and said downlink direction.

10. The non-transitory machine readable medium of claim 9, wherein said packet is received in said downlink direction to a first end device as said destination system, wherein said first layer-2 address is that of said first end device, said non-transitory machine readable medium further comprising instructions for enabling said wireless node to perform the actions of:
operating both as an access point (AP) and a wireless station (STA) according to IEEE 802.11 standards, wherein said STA of said wireless node associates with an AP of a second wireless node, and a STA of a third wireless node associating with said AP of said wireless node, wherein said wireless node, said second wireless node and said third wireless node are in a path to said first end device,
wherein said second wireless node is after said wireless node in said uplink direction, and said third wireless node is before said wireless node in said uplink direction, wherein said first layer-2 packet is received by said STA of said wireless node from said AP of said second wireless node, and said first layer-2 packet is forwarded by said AP of said wireless node to said STA of said third wireless node.

11. The non-transitory machine readable medium of claim 10, wherein said first layer-2 packet does not contain a layer-2 address of any of said second wireless node, said wireless node and said third wireless node as a destination address, while being forwarded in said path.

12. The non-transitory machine readable medium of claim 10, wherein said first layer-2 address is a unicast address, said non-transitory machine readable medium further comprising instructions for enabling said wireless node to perform the actions of:
examining said link information for an entry corresponding to said first layer-2 address of said end device,
wherein said first layer-2 packet is forwarded by said AP of said wireless node to said STA of said third wireless node only if said entry is present in said link information.

13. The non-transitory machine readable medium of claim 12 further comprising instructions for enabling said wireless node to perform the actions of:
receiving, by said wireless node, a second layer-2 packet on said wireless medium in said uplink direction, said second layer-2 packet containing said first layer-2 address of said first end device indicating that said first end device is said source system for said second layer-2 packet;
forwarding said second layer-2 packet with no source address equaling a layer-2 address of said AP of said wireless node or said STA of said wireless node, but with a source address equaling said first layer-2 address of said end device; and
updating, in said wireless node, said link information to indicate that said end device is present in said downlink direction,
wherein said second layer-2 packet is received before said first layer-2 packet.

14. The non-transitory machine readable medium of claim 13, wherein said second layer-2 packet is a layer-2 broadcast packet according to dynamic host configuration protocol (DHCP) for obtaining an IP address for said first end device,
wherein said layer-2 broadcast packet is forwarded by said wireless node to said AP of said second wireless node as being the next node in said uplink direction in view of an association of the STA of said wireless node with said AP of said second wireless node,
wherein said first layer-2 packet is received as a response to said layer-2 broadcast packet from a DHCP server also operating as a corresponding AP.

15. The non-transitory machine readable medium of claim 13, wherein said STA of said wireless node establishes an association between said first end device and said AP of said second wireless node, said association being according to IEEE 802.11 standard,
wherein said STA of said wireless node encrypts said second layer-2 packet with a first security key corresponding to said association between said first end device and said AP of said second wireless node, and forwards a first encrypted second layer-2 packet to said AP of said second wireless node,
wherein said AP of said second wireless node decrypts said first encrypted second layer-2 packet using said first security key to obtain said second layer-2 packet.

16. The non-transitory machine readable medium of claim 15, wherein said STA of said third wireless node establishes an association between said first end device and said AP of said wireless node, said association being according to IEEE 802.11 standard,
wherein, said STA of said third wireless node encrypts said second layer-2 packet with a second security key corresponding to said association between said first end device and said AP of said wireless node, and forwards a second encrypted second layer-2 packet to said AP of said wireless node,
wherein said AP of said wireless node decrypts said second encrypted second layer-2 packet using said second security key to obtain said second layer-2 packet.

17. A wireless node of a wireless network, said wireless device comprising:
a transmitter;
a receiver;
a memory; and
a processor operable to perform the actions of:
maintaining link information for a set of layer-2 addresses, each layer-2 address corresponding to a medium access control (MAC) address of a corresponding device transmitting packets on said wireless network, said link information indicating whether the corresponding device is in an uplink direction or a downlink direction;
receiving, through said receiver, a first layer-2 packet on a wireless medium in one of said uplink direction and said downlink direction, said first layer-2 packet containing a first layer-2 address specifying a destination system, with no layer-2 address in said first layer-2 packet indicating that the packet is destined to said wireless node; and
forwarding, through said transmitter, said first layer-2 packet on said wireless medium to a next wireless device in said one of said uplink direction and said downlink direction.

18. The wireless node of claim 17, wherein said packet is received in said downlink direction to a first end device as said destination system, wherein said first layer-2 address is that of said first end device, said processor is further operable to:
cause said wireless node to operate both as an access point (AP) and a wireless station (STA) according to IEEE 802.11 standards, wherein said STA of said wireless node associates with an AP of a second wireless node, and a STA of a third wireless node associating with said AP of said wireless node, wherein said wireless node, said second wireless node and said third wireless node are in a path to said first end device,
wherein said second wireless node is after said wireless node in said uplink direction, and said third wireless node is before said wireless node in said uplink direction,
wherein said first layer-2 packet is received by said STA of said wireless node from said AP of said second wireless node, and said first layer-2 packet is forwarded by said AP of said wireless node to said STA of said third wireless node.

19. The wireless node of claim 18, wherein said first layer-2 packet does not contain a layer-2 address of any of said second wireless node, said wireless node and said third wireless node as a destination address, while being forwarded in said path.

20. The wireless node of claim 18, wherein said first layer-2 address is a unicast address, said processor further operable to:
examine said link information for an entry corresponding to said first layer-2 address of said end device,
wherein said first layer-2 packet is forwarded by said AP of said wireless node to said STA of said third wireless node only if said entry is present in said link information.
